(19) United States
(12) Patent Application Publication
(10) Pub. No.: US 2006/0173828 A1
(43) Pub. Date: Aug. 3, 2006

(54) Methods and apparatus for using personal background data to improve the organization of documents retrieved in response to a search query

(75) Inventor: Louis B. Rosenberg, Pismo Beach, CA (US)

Correspondence Address: SINSHEIMER, SCHIEBELHUT, BAGGETT, 1010 PEACH STREET, SAN LUIS OBISPO, CA, 93401, US

(73) Assignee: Outland Research, LLC, Pismo Beach, CA (US)

(21) Appl. No.: 11/298,797

(22) Filed: Dec. 9, 2005

Related U.S. Application Data
(60) Provisional application No. 60/649,240, filed on Feb. 1, 2005.

(51) Int. Cl. G06F 7/00

(52) U.S. Cl. 707/3

(57) ABSTRACT

A computerized method of organizing a set of documents includes receiving a search query from a user; obtaining personal background data from the user; identifying at least one personal background trait within the personal background data, the personal background trait being statistically correlated with documents that the user is likely to prefer; identifying a plurality of documents responsive to the search query; assigning a score to each identified document based upon a correlation between advanced usage information for each document and the identified personal background trait, the advanced usage information describing at least one of a number and frequency of users who have previously accessed the document who possess the identified personal background trait; and organizing the documents based at least in part on the assigned score.

This application claims the benefit of U.S. Provisional Application No. 60/649,240 filed Feb. 1, 2005, which is incorporated in its entirety herein by reference.

### BACKGROUND OF THE INVENTION

1. Field of the Invention

The present invention relates generally to internet search engines and, more particularly, to employing personal background data and advanced usage information to improve information search, retrieval, and organization, during internet searching.

2. Discussion of the Related Art

The World Wide Web (“web”) contains a vast amount of information. Locating a desired portion of the information, however, can be challenging. This problem is compounded because the amount of information on the web and the number of new users who are inexperienced at web research is growing rapidly.

People generally surf the web based on its link graph structure, often starting with high quality human-maintained indices or use search engines such as Google or Yahoo. Human-maintained lists cover popular topics effectively but are subjective, expensive to build and maintain, slow to improve, and do not cover all esoteric topics.

Automated search engines, in contrast, locate web sites by matching search terms entered by the user to an indexed corpus of web pages. Generally, the search engine returns a list of web sites sorted based on relevance to the user's search terms. Determining the correct relevance, or importance, of a web page to a user, however, can be a difficult task. For one thing, the importance of a web page to the user is inherently subjective and depends on the user's interests, knowledge, and attitudes. There is, however, much that can be determined objectively about the relative importance of a web page.

Conventional methods of determining relevance are based on matching a user's search terms to terms indexed from web pages. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. Another known method is disclosed in US Patent Application Publication No. 2002/0123988, as published on Sep. 5, 2002, and is hereby incorporated by reference into this specification.

Each of these conventional methods has shortcomings, however. Term-based methods are biased towards pages whose content or display is carefully chosen towards the given term-based method. Thus, they can be easily manipulated by the designers of the web page. Link-based methods have the problem that relatively new pages have usually fewer hyperlinks pointing to them than older pages, which tends to give a lower score to newer pages. There exists, therefore, a need to develop other techniques for determining the importance of documents.

### SUMMARY OF THE INVENTION

Several embodiments of the invention advantageously address the needs above as well as other needs by providing methods and apparatus for using personal background data to improve the organization of documents retrieved in response to a search query.

In one embodiment, the invention can be characterized as a computerized method of organizing a set of documents that includes receiving a search query from a user; obtaining personal background data from the user; identifying at least one personal background trait within the personal background data, the personal background trait being statistically correlated with documents that the user is likely to prefer; identifying a plurality of documents responsive to the search query; assigning a score to each identified document based upon a correlation between advanced usage information for each document and the identified personal background trait, the advanced usage information describing at least one of a number and frequency of users who have previously accessed the document who possess the identified personal background trait; and organizing the documents based on the assigned score.

In still another embodiment, the invention can be characterized as an apparatus for organizing a set of documents that includes means for receiving a search query from a user; means for obtaining personal background data from the user; means for identifying at least one personal background trait within the personal background data, the personal background trait being statistically correlated with documents that the user is likely to prefer; means for identifying a plurality of documents responsive to the search query; means for assigning a score to each identified document based upon a correlation between advanced usage information for each document and the identified personal background trait, the advanced usage information describing at least one of a number and frequency of users who have previously accessed the document who possess the identified personal background trait; and means for organizing the documents based on the assigned score.

In a further embodiment, the invention may be characterized as an apparatus for organizing a set of documents that includes circuitry having executable instructions; and at least one processor configured to execute the program instructions to perform operations of: receiving a search query from a user; obtaining personal background data from the user; identifying at least one personal background trait within the personal background data, the personal background trait being statistically correlated with documents that the user is likely to prefer; identifying a plurality of documents responsive to the search query; assigning a score to each identified document based upon a correlation between advanced usage information for each document and the identified personal background trait, the advanced usage information describing at least one of a number and frequency of users who have previously accessed the document who possess the identified personal background trait; and organizing the documents based on the assigned score.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram illustrating an exemplary network in which concepts consistent with the present invention may be implemented;

FIG. 2 illustrates a flow diagram, consistent with the invention, for organizing documents based on usage information;

FIG. 3 illustrates a flow chart describing the computation of usage information;

FIG. 4 illustrates a few techniques for computing the frequency of visits, consistent with the invention.

FIG. 5 illustrates a few techniques for computing the number of unique users, consistent with the invention; and

FIG. 6 depicts an exemplary method, consistent with the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Consistent with numerous embodiments of the present invention, methods and apparatus described herein use personal background traits of a user who initiates a search to better organize the search results presented to that user. Exemplary embodiments of the present invention generally provide a method of organizing a set of documents by receiving a search query, identifying a plurality of documents responsive to the search query, assigning a score to each identified document based (in whole or in part) upon a degree of correlation that advanced usage information for each identified document has with at least a portion of personal background data specific to the user, and organizing the documents based on the assigned scores.

In one embodiment, a user's personal background data is characterized by one or more personal background traits that are specific to the user and that can be statistically correlated with the documents (e.g., as measured by type, quality, sophistication, and/or socio-political bias) that the user is likely to prefer. Accordingly, personal background traits included within a user's personal background data include political association (e.g., affiliation, identification, etc.), the highest level of education, profession, marital status, reading level, or the like, or combinations thereof.

In one embodiment, personal background traits can be represented within the personal background data as a binary value or a numerical value. For example, a binary value (e.g., 0 or 1) indicates whether or not a user has a particular personal background trait (e.g., whether or not a user is associated with a particular political party). In another example, a particular numerical value (selected from a scale of values as a rating or ranking) indicates the degree to which the particular personal background trait defines the user. For example, the personal background data may indicate: a) that a particular user is a Democrat; and b) that the particular user is rated as a 6.0 on a scale of 1.0 to 10.0, wherein the scale rates the degree of affiliation from moderate to extreme (e.g., a 1.0 being moderate and a 10.0 being extreme). In this way, the personal background data represents not just the political affiliation but the degree to which political affiliation may represent the personal beliefs, biases, view, and interests of that particular user.

Another exemplary embodiment of the present invention describes a method wherein search query is received and a list of responsive documents is identified. The list of responsive documents may be based on a comparison between the search query and the contents of the documents, or by other conventional methods. Personal background data is also accessed (e.g., either from a previous store of personal background data in local or remote storage or through a query to the user prior to or during the search).

Other exemplary embodiments of the present invention describe methods and systems for storing and processing data related to web page usage and personal background traits of users who have accessed web pages (i.e., advanced usage information). Typically, usage information includes information about a web page that describes how many users visited the web-page (e.g., over a period of time) and/or how often users visited the web-page (e.g., over a period of time). As disclosed herein, advanced usage information (also referred to as advanced usage data) does not only represent how often a particular web page is accessed, but also correlates one or more traits from the personal background data of those users who access a web page with usage. Thus, advanced usage information associated with a document (e.g., a web page) does not just how often a web page is accessed, but also, for example, how often it is accessed by users having one or more specific personal background traits (e.g., identifying users having a political affiliation of Democrat, Republican, etc., identifying users who are professional engineers, etc., identifying users who have a college level education, etc., or the like, or combinations thereof).

By determining and storing the advanced usage information for each document as described above, methods and systems disclosed herein can be applied to optimize the ordering of search results for a given user. For example, if a user makes a query to the search methods and systems disclosed herein, and that user has personal background data that identifies him or her as a Democrat with a college education, the ordering of search results presented to that user may then be based (in whole or in part) upon the frequency and/or number of times that other users who are also identified as Democrats have accessed a given web page. In addition, the ordering of search results presented to the user in this example may also be based (in whole or in part) upon the frequency and/or number of times that other users who are identified as having a college education have accessed a given web page. In this way, one or more of the traits represented by the personal background data for a given user can be used in conjunction with advanced usage information to order and present search results to that user.

If multiple personal background traits are used to order the search results in a given search (e.g., both the political affiliation and the highest level of education of the user in the example above), the multiple personal background traits can be equally weighted in their impact upon the ordering of the search results, or the multiple personal background traits can be weighted differently in their impact upon the search results. The relative importance of multiple traits stored within a user's personal background data (e.g., the relative importance that political affiliation has as compared to highest level of education) can, itself, be stored within a user's personal background data. For example, each of the multiple traits stored within a user's personal background data can have an importance factor or other weighting variable associated with it, wherein the importance or weighting factor reflects the relative importance of such traits to that individual user. For example, a particular user may view his political affiliation as more representative of his views, biases, attitudes, and interests, than his profession as reflected by importance factors stored within his personal background data. In some embodiments, the importance factors are used, in part, to order search results, thereby accounting for the relative importance that multiple personal background traits may have to a given user. Alternatively, the relative importance of multiple personal background traits can be variables set and used by the ordering algorithm, independent of the personal background data of the user. For example, an ordering algorithm following the methods disclosed herein may be configured to always treat a political affiliation trait as being twice as important as a user profession trait when ordering search results.

A. Architecture

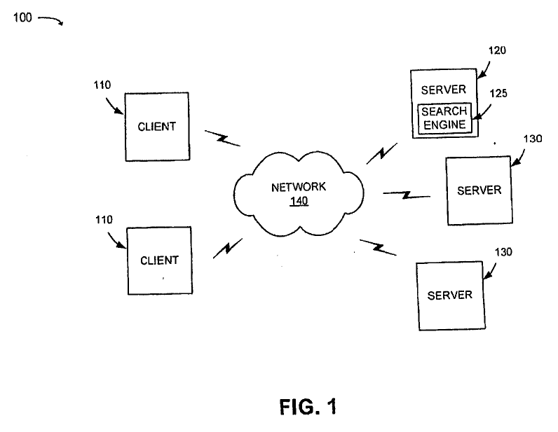

FIG. 1 illustrates a system 100 in which methods and apparatus, consistent with the present invention, may be implemented.

Referring to FIG. 1, the system 100 may include multiple client devices 110 connected to multiple servers 120 and 130 via a network 140. The network 140 may include a local area network (LAN), a wide area network (WAN), a telephone network, such as the Public Switched Telephone Network (PSTN), an intranet, the Internet, or a combination of networks. Two client devices 110 and three servers 120 and 130 have been illustrated as connected to network 140 for simplicity. In practice, there may be more or less client devices and servers. Also, in some instances, a client device may perform the functions of a server and a server may perform the functions of a client device.

The client devices 110 may include devices, such mainframes, minicomputers, personal computers, laptops, personal digital assistants, or the like, capable of connecting to the network 140. The client devices 110 may transmit data over the network 140 or receive data from the network 140 via a wired, wireless, or optical connection.

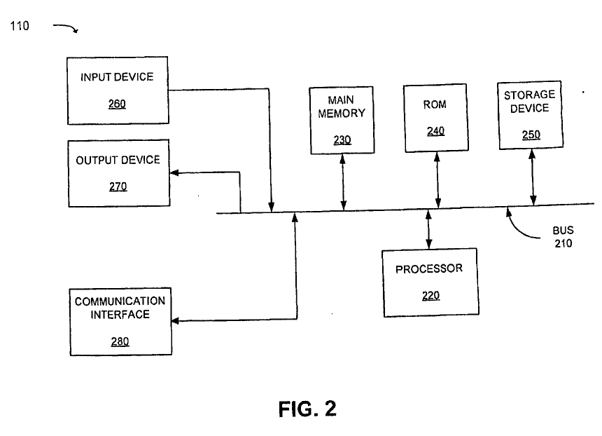

FIG. 2 illustrates an exemplary client device 110 consistent with the present invention.

Referring to FIG. 2, the client device 110 may include a bus 210, a processor 220, a main memory 230, a read only memory (ROM) 240, a storage device 250, an input device 260, an output device 270, and a communication interface 280.

The bus 210 may include one or more conventional buses that permit communication among the components of the client device 110. The processor 220 may include any type of conventional processor or microprocessor that interprets and executes instructions. The main memory 230 may include a random access memory (RAM) or another type of dynamic storage device that stores information and instructions for execution by the processor 220. The ROM 240 may include a conventional ROM device or another type of static storage device that stores static information and instructions for use by the processor 220. The storage device 250 may include a magnetic and/or optical recording medium and its corresponding drive.

The input device 260 may include one or more conventional mechanisms that permit a user to input information to the client device 110, such as a keyboard, a mouse, a pen, voice recognition and/or biometric mechanisms, etc. The output device 270 may include one or more conventional mechanisms that output information to the user, including a display, a printer, a speaker, etc. The communication interface 280 may include any transceiver-like mechanism that enables the client device 110 to communicate with other devices and/or systems. For example, the communication interface 280 may include mechanisms for communicating with another device or system via a network, such as network 140.

As will be described in detail below, the client devices 110, consistent with the present invention, may perform certain document retrieval operations. The client devices 110 may perform these operations in response to processor 220 executing software instructions contained in a computer-readable medium, such as memory 230. A computer-readable medium may be defined as one or more memory devices and/or carrier waves. The software instructions may be read into memory 230 from another computer-readable medium, such as the data storage device 250, or from another device via the communication interface 280. The software instructions contained in memory 230 causes processor 220 to perform search-related activities described below. Alternatively, hardwired circuitry may be used in place of or in combination with software instructions to implement processes consistent with the present invention. Thus, the present invention is not limited to any specific combination of hardware circuitry and software.

The servers 120 and 130 may include one or more types of computer systems, such as a mainframe, minicomputer, or personal computer, capable of connecting to the network 140 to enable servers 120 and 130 to communicate with the client devices 110. In alternative implementations, the servers 120 and 130 may include mechanisms for directly connecting to one or more client devices 110. The servers 120 and 130 may transmit data over network 140 or receive data from the network 140 via a wired, wireless, or optical connection.

The servers may be configured in a manner similar to that described above in reference to FIG. 2 for client device 110. In an implementation consistent with the present invention, the server 120 may include a search engine 125 usable by the client devices 110. The servers 130 may store documents (or web pages) accessible by the client devices 110 and may perform document retrieval and organization operations, as described below.

B. Architectural Operation

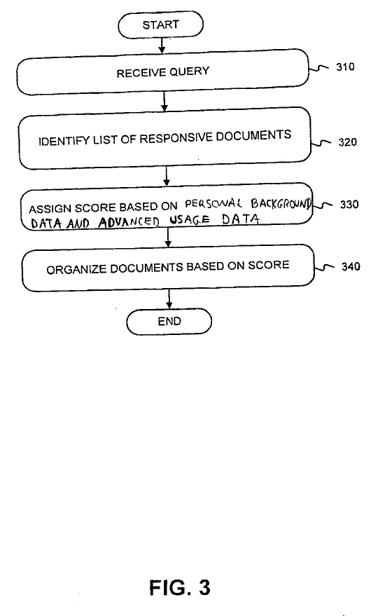

FIG. 3 illustrates a flow diagram, consistent with the invention, for organizing documents based on both personal background data related to the user who performs a search and advanced usage information related to the web pages that are retrieved during the search. At stage 310, a search query is received by search engine 125 as entered by the user. The query may contain text, audio, video, or graphical information. At stage 320, search engine 125 identifies a list of documents that are responsive (or relevant) to the search query. This identification of responsive documents may be performed in a variety of ways, consistent with the invention, including conventional ways such as comparing the search query to the content of the document.

Once this set of responsive documents has been determined, it is necessary to organize the documents in some manner. In one embodiment, this may be achieved by employing a correlation between a user's personal background data and advance usage information associated with the document. In another embodiment, this may be achieved by employing a correlation between a user's personal background data and advanced usage information associated with the document. In the particular embodiment represented by FIG. 3, this is achieved by employing advanced usage information.

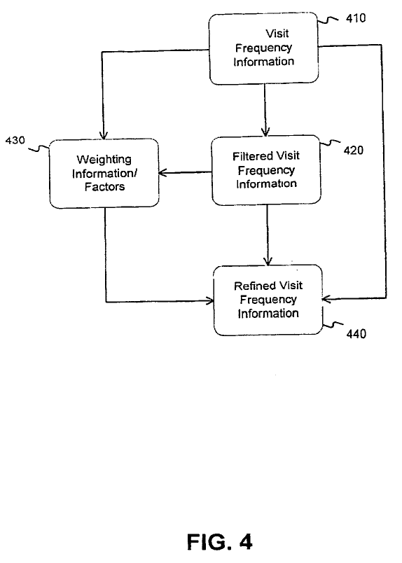

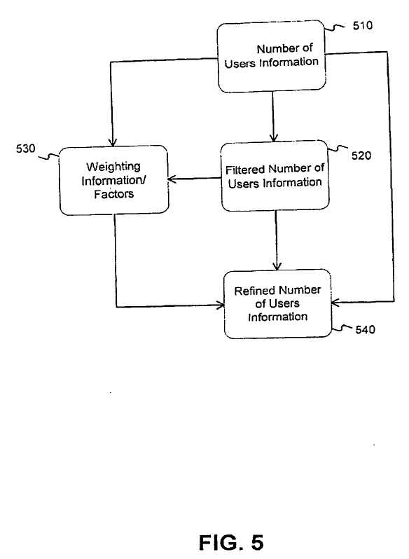

As shown at stage 330, scores are assigned to each document based on the advanced usage information, including based upon how well the advanced usage information correlates with the personal background data of the user. The scores may be absolute in value or relative to the scores for other documents. The scores are weighed based upon correlation with the user's personal usage information. For example, a web site having advanced usage information that shows heavy use (i.e. many visits and/or frequent visits) by users who have personal background traits that are well-matched to traits in the personal background data of the user who initiated the search will receive a particularly high score. This process of assigning scores, which may occur before or after the set of responsive documents is identified, can be based on a variety of advanced usage information and advanced usage information. As described above, the advanced usage information comprises information about both the number of unique visits and the frequency of visits (collectively referred to as “visit information”) and correlates the visit information with specific advanced usage information (i.e., specific personal background data of the users who have accessed the documents—e.g., visited the sites). Accordingly, the advanced usage information includes, for example, not only data about how many unique visitors have visited a site during a particular time period, but also how many of the visitors were affiliated with a particular political party, a particular profession, a particular highest level of education, etc. The correlations can be stored as absolute numbers or as relative percentages. The advanced usage information is described further in reference to FIGS. 4 and 5.

The advanced usage information and personal background data may be maintained at client 110 and transmitted to search engine 125. The location of the advanced usage information is not critical, however, and it could also be maintained in other ways. For example, the advanced usage information may be maintained at servers 130, which forward the advanced usage information to search engine 125; or the advanced usage information may be maintained at server 120 if it provides access to the documents (e.g., as a web proxy).

At stage 340, the responsive documents are organized based on the assigned scores. The documents may be organized based entirely on the scores derived from advanced usage information of the retrieved web pages and the personal background data of the user who has initiated the search. Alternatively, they may be organized based on the assigned scores in combination with other factors. For example, the documents may be organized based on the assigned scores combined with link information and/or query information. Link information involves the relationships between linked documents, and an example of the use of such link information is described in the Brin & Page publication referenced above. Query information involves the information provided as part of the search query, which may be used in a variety of ways to determine the relevance of a document. Other information, such as the length of the path of a document, could also be used.

In one implementation, documents are organized based on a total score that represents the product of an advanced usage score and a standard query-term-based score (“IR score”). In particular, the total score equals the square root of the IR score multiplied by the advanced usage score. The advanced usage score, in turn, equals a frequency of visit score (weighed by a degree of correlation with personal background data) multiplied by a unique user score (also weighed by a degree of correlation with personal background data) multiplied by a path length score (optionally weighted by a degree of correlation with personal background data).

In one embodiment, a first frequency of visit score equals log 2(1+log(VF)/log(MAXVF). VF is the number of times that the document was visited (or accessed) in one month, and MAXVF is set to 2000. A second frequency of visit score is then calculated based upon a correlation with the searching user's personal background data and the advanced usage information stored related to the document in question. For example, if the personal background data of the user who initiated the search indicates that that user is a Democrat, the advanced usage information stored for the document in question will be used to compute a frequency of visit score equal to log 2(1+log(VF1)/log(MAXVF1) where VF1 is the number of times that the document was visited (or accessed) in one month by other unique users who had a first personal background trait (e.g., political affiliation of Democrats) within their personal background data, and MAXVF1 is set to 2000. A third frequency of visit score is then computed based upon the first frequency of visit score and the second frequency of visit score, scoring this site based both on the total number of visits as well as the number of visits by user's sharing the same personal background trait (e.g., a political affiliation of Democrat) that was used from the personal background data of the user who initiated the search. Numerous other personal background traits may be present in the personal background data of the user who performed the search (e.g., level of education, profession, etc.). Two, three, or more of the personal background traits can be used in the methods disclosed herein, each for example being used to compute third, forth, and further frequency of visit scores.

As for computing VF, VF1, VF2, or any further visitor frequency value correlated with a personal background trait, the following is one method of doing so. VF is computed as being equal to 0.5*(1+UU/MAXUU) where UU is the number of unique visitors that access the document in one month, and MAXUU is set to a reasonable constant such as 400. A small value is used when UU is unknown. VF1, in the example above, is computed as being equal to 0.5*(1+UU1/MAXUU1) where UU1 is the number of unique visitors who have a first personal background trait (e.g., political affiliation of Democrats) and that access the document in one month, and MAXUU1 is set to a reasonable constant such as 400. The number of unique visitors can be determined by monitoring host/IP data and/or other user identification data. The path length score equals log(K−PL)/log(K), where PL is the number of ‘/’ characters in the document's path and K is set to 20.

FIG. 4 illustrates a few techniques for computing the frequency of visits to a web document as correlated with personal background data stored within the advanced usage information. The computation begins with one or more counts at 410, one of which may be a raw count and may be an absolute or relative number corresponding to the visit frequency for the document. For example, the raw count may represent the total number of times that a document has been visited. Alternatively, the raw count may represent the number of times that a document has been visited in a given period of time (e.g., over the past week), the change in the number of times that a documents has been visited in a given period of time (e.g., 20% increase during this week compared to the last week), or any number of different ways to measure how frequently a document has been visited. In one implementation, this raw count is used as the refined visit frequency 440, as shown by the path from 410 to 440.

In addition to the raw count as described above at 410, one or more personal background trait-specific counts are also available at 410. Each of the personal background trait-specific counts may be provided as either an absolute or relative number corresponding to the visit frequency of users who visited the document who had certain traits within their personal background data. For example, if the personal background data of a user visiting a specific document includes a variable for political affiliation, the variable set to Democrat, a personal background trait-specific count associated with the trait Democrat would be increased by one. In this way, trait-specific count variables can be initialized and incremented and the number of visitors who have one or more specific personal background traits within their personal background data can be tallied. For example, a personal background trait-specific count may represent the total number of times that a document has been visited by users whose personal background data indicated that they have a political affiliation trait set to Democrat. Alternatively, the count may represent the number of times that a document has been visited by users who have personal background data that indicates they have a political affiliation trait set to Democrat in a given period of time (e.g., over the past week), the change in the number of times that a documents has been visited by users who have personal background data that indicates they have a political affiliation trait set to Democrat in a given period of time (e.g., 20% increase during this week compared to the last week), or any number of different ways to measure how frequently a document has been visited by users who have personal background data that indicates they have a political affiliation trait set to Democrat. In one implementation, this count is used as the refined visit frequency. In some implementations numerous traits are independently counted so that multiple factors in the personal background data can be used simultaneously to correlate with the personal background data of given user performing a search. Whereas the counting of the total number of visits is described in the previous paragraph as the raw count, the counting of the number of visits as correlated with a particular personal background trait (such as political affiliation of Democrat, highest education level of graduate school, or profession of engineer) will each be referred to herein as a personal-trait specific count. While there is typically one raw count for a given web document there may be many personal-trait specific counts, each associated with a different personal background trait represented in the personal background data associated with visiting users.

In other implementations, the raw count and/or personal-trait specific counts may be processed using any of a variety of techniques to develop a refined visit frequency, with a few such techniques being illustrated in FIG. 4. As shown by 420, the raw count and/or personal-trait specific counts may be filtered to remove certain visits. For example, one may wish to remove visits by automated agents or by those affiliated with the document at issue, since such visits may be deemed to not represent objective usage. This filtered count 420 may then be used to calculate the refined visit frequency 440.

Instead of, or in addition to, filtering the raw count and/or personal-trait specific counts, the count may be weighted based on the nature of the visit (430). For example, one may wish to assign a weighting factor to a visit based on the geographic source for the visit (e.g., counting a visit from Germany as twice as important as a visit from Antarctica). Any other type of information that can be derived about the nature of the visit (e.g., the browser being used, information concerning the user, etc.) could also be used to weight the visit. This weighted visit frequency 430 may then be used as the refined visit frequency 440.

Although only a few techniques for computing the visit frequency are illustrated in FIG. 4, those skilled in the art will recognize that there exist other ways for computing the visit frequency, consistent with the invention.

FIG. 5 illustrates a few techniques for computing the total number of unique users as well as the number of unique users that have one or more traits represented within their personal background data. As with the techniques for computing visit frequency illustrated, the computation begins with a one or more counts at 510, one of which may be a raw count and may be an absolute or relative number corresponding to the number of unique users who have visited the document. Alternatively, the raw count may represent the number of unique users that have visited a document in a given period of time (e.g., 30 users over the past week), the change in the number of unique users that have visited the document in a given period of time (e.g., 20% increase during this week compared to the last week), or any number of different ways to measure how many unique users have visited a document. The identification of the unique users may be achieved based on the user's Internet Protocol (IP) address, their hostname, cookie information, or other user or machine identification information. In one implementation, this raw count is used as the refined number of users 540, as shown by the path from 510 to 540.

In addition to the raw count as described above at 510, one or more personal background trait-specific counts are also available at 510. Each of the personal background trait-specific counts can be an absolute or relative number corresponding to the visit frequency of users who visited the document who had certain traits within their personal background data. For example, if the personal background data of a unique user visiting a specific document includes a variable for political affiliation, the variable set to Democrat, a personal background trait-specific count associated with the trait Democrat would be increased by one. In this way trait-specific count variables can be initialized and incremented and the number of unique visitors who have one or more specific personal background traits within their personal background data can be tallied. For example, the count may represent the total number of times that a document has been visited by unique users whose personal background data indicates that they have a political affiliation trait set to Democrat. Alternatively, the count may represent the number of times that a document has been visited by unique users who have personal background data that indicates they have a political affiliation trait set to Democrat in a given period of time (e.g., over the past week), the change in the number of times that a documents has been visited by unique users who have personal background data that indicates they have a political affiliation trait set to Democrat in a given period of time (e.g., 20% increase during this week compared to the last week), or any number of different ways to measure how the number of times a document has been visited by unique users who have personal background data that indicates they have a political affiliation trait set to Democrat. In some implementations, numerous traits can be independently counted so that multiple factors in the personal background data can be used simultaneously to correlate with the personal background data of given user performing a search. Whereas the counting of the total number of unique visits is described in the previous paragraph as the raw count, the counting of the number of unique visits as correlated with a particular personal background trait (such as political affiliation of democrat, highest education level of graduate school, or profession of engineer) will each be referred to herein as a personal-trait specific count. While there is typically one raw count for a given web document there may be many personal-trait specific counts, each associated with a different personal background trait represented in the personal background data associated with unique visiting users.

In other implementations, the raw count and/or personal-trait specific counts may be processed using any of a variety of techniques to develop a refined user count, with a few such techniques being illustrated in FIG. 5. As shown by 520, the counts may be filtered to remove certain users. For example, one may wish to remove users identified as automated agents or as users affiliated with the document at issue, since such users may be deemed to not provide objective information about the value of the document. This filtered count 520 may then be used to calculate a refined user count 540.

Instead of, or in addition to, filtering the raw count and/or the personal-trait specific counts, the counts may be weighted based on the nature of the user (530). For example, one may wish to assign a weighting factor to a visit based on the geographic source for the visit (e.g., counting a user from Germany as twice as important as a user from Antarctica). Any other type of information that can be derived about the nature of the user (e.g., browsing history, bookmarked items, etc.) could also be used to weight the user. This weighted user information 530 may then be used as a refined user count 540.

Although only a few techniques for computing the number of unique users are illustrated in FIG. 5, those skilled in the art will recognize that there exist other ways for computing the number of unique users, consistent with the invention. Furthermore, although FIGS. 4 and 5 illustrate determining advanced usage information on a document-by-document basis, other techniques consistent with the information may be used to associate advanced usage information with a document. For example, rather than maintaining advanced usage information for each document, one could maintain advanced usage information on a site-by-site basis. This site advanced usage information could then be associated with some or all of the documents within that site.

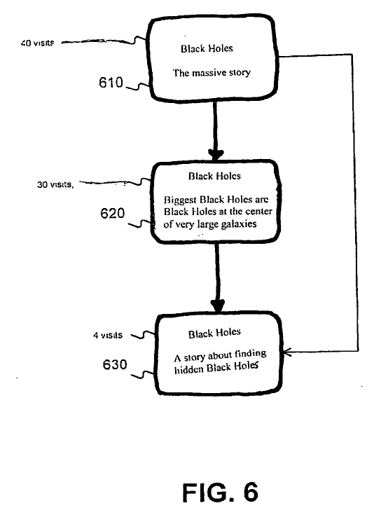

FIG. 6 depicts an exemplary method employing visit frequency information, consistent with embodiments of the present invention. FIG. 6 depicts three documents, 610, 620, and 630, which are responsive to a search query for the term “black holes”. Document 610 is shown to have been visited 40 times over the past month, with 15 of those 40 visits being by automated agents. Of the 25 non-automated visits, document 610 is shown to have been visited 10 times by users who have personal background data identifying them as having achieved a college degree as their highest level of education, visited by 12 times by users who have personal background data identifying them as having finished high school as their highest level of education, and visited by 3 users having personal background data identifying them has having completed 10th grade as their highest level of education. Document 620, which is linked to document 610, is shown to have been visited 30 times over the past month. Of the 30 visits, document 620 is shown to have been visited 20 times by users who have personal background data identifying them as having achieved a college degree as their highest level of education, visited by 7 times by users who have personal background data identifying them as having finished high school as their highest level of education, and visited by 3 users having personal background data identifying them has having completed 10th grade as their highest level of education. Document 630, which is linked to documents 610 and 620, is shown to have been visited 4 times over the past month. Of the 4 visits, this document is shown to have been visited 0 times by users who have personal background data identifying them as having achieved a college degree as their highest level of education, visited by 0 times by users who have personal background data identifying them as having finished high school as their highest level of education, and visited by 2 users having personal background data identifying them has having completed 10th grade as their highest level of education.

Under a conventional term frequency based search method, the documents are organized based on the frequency with which the search query term (“black holes”) appears in the document. Accordingly, the documents are organized into the following order: document 620 (assuming three occurrences of “black holes” were found), document 630 (assuming two occurrences of “black holes” were found), and document 610 (assuming one occurrence of “black holes” were found).

Under a conventional link-based search method, the documents are organized based on the number of other documents that link to those documents. Accordingly, the documents may be organized into the following order: 630 (linked to by two other documents), 620 (linked to by one other document), and 610 (linked to by no other documents).

Methods and apparatus consistent with the invention employ both personal background data and advanced usage information to aid in organizing documents. For example, the methods identify by reviewing the personal background data of the user who is currently performing the search that the user, for example, has a highest level of education that is a college degree. The document may then be organized not based simply upon the number of visits, the number of non-automated visits, or the distribution of visits from various IP addresses in certain locations, but upon the specific personal background traits of the user who is performing the search (in this example, the trait being his highest level of education). Using highest level of education as the ordering metric and accounting visits as the number of visits from users who have completed a college degree, the documents may be organized in the following order: document 620 (20 visits from users who have a college degree) document 610 (15 visits from users who have a college degree), and document 630 (0 visits from users who have a college degree).

Instead of using only the personal background data of the user or only the advanced usage information for the documents, the personal background data and advanced usage information may be used in combination with the query information and/or the link information to develop the ultimate organization of the documents.

As used herein, the personal background traits within personal background data do not merely refer to a historical record of a user's web behavior (e.g., browsing history, bookmark history, and/or cookie data). Personal background traits within personal background data are user-specific factual information about the user's personal background that identifies one or more personal background traits of the user and associates the user with a particular demographic population of people with a similar trait or traits, regardless of when, from where, or how the user is conducting a search. In many embodiments, the personal background data is reported by the user. For example a user's political affiliation can be a form of personal background data, indicative of a user's personal views and biases towards political matters and associating that person with other people who are likely to have similar views and biases towards political matters. Conversely, an indication of what kind of computer operating system a user is using when conducting a particular search is not personal background data because a computer operating system is a property of the computer being used—not a trait of the user himself or herself. That same user could search the internet from any one of many different computers during a given hour, day, month, or year, each of the computers having a different configuration, using different software, being at a different location, and providing different capabilities. In many cases, the choice of operating system, web browser, computer type, computer location, or other hardware and/or software configuration of the computer used to perform a given search, is a decision that is imposed upon the user by the company, institution, or household within which the computer resides and is not a trait of the user himself or herself. The paragraphs below discuss exemplary embodiments of personal background data:

Political Affiliation: Political affiliation is a personal background trait that can be stored in personal background data and can be an effective factor used in organizing and presenting the results of an internet search because political affiliation is a demographic categorization that has a high statistical probability reflecting the views, beliefs, biases, likes, dislikes, and inclinations of a particular user. Because many users frequently search for news information, historical information, or other documents that are highly colored by views, beliefs, biases, likes, dislikes, and inclinations, using political affiliation as a factor in organizing and presenting the results of an internet search can be highly desirable to many users.

Highest level of education: Highest level of education completed is a personal background trait that can be stored in personal background data and can be an effective factor used in organizing and presenting the results of an internet search because documents on the internet are written at differing levels of complexity and address differing levels of detail. A college professor with a Ph.D. is likely to prefer internet documents written a different level of complexity and detail than a high school dropout. Both the college professor and the high school dropout may be interested in searching the same topic—for example, global warming. Using the methods disclosed herein, web documents pertaining to global warming can be categorized not simply by how many users have accessed those documents, but can be categorized specifically by the how many users of various educational backgrounds (highest level of education) have accessed those documents. In this way, the high school dropout who searches global warming (his highest level of education indicated in his personal background data or prompted by the search engine at the time the search is conducted) would be likely presented search results ordered in a way such that the documents that were accessed often by other high school dropouts were most highly ranked. This is likely to result in the most highly ranked documents being those that use simpler language and less complex details would be most highly ranked. Conversely, the college professor with the Ph.D. would be likely presented with search results ordered in a way such that the document that were accessed often by other people who completed Ph.D. level education were most highly ranked. This is likely to result in the most highly ranked documents being those that use more sophisticated language and more complex factual details.

Profession: A user's profession is a personal background trait that can be stored in personal background data and can be an effective factor used in organizing and presenting the results of an internet search because documents on the internet are written at differing levels of complexity and address differing levels of detail. A professional engineer is likely to prefer internet documents written a different level of complexity and detail than a graphic designer. Both the professional engineer and graphic designer may be interested in searching the same topic—for example, museums. Using the methods disclosed herein, web documents pertaining to museums can be categorized not simply by how many users have accessed those documents, but can be categorized specifically by the how many users of various professions have accessed those documents. In this way, the engineer who searches museums would be presented search results ordered in a way such that documents accessed often by other engineers were highly ranked. For example, it might be that documents relating to science and technology museums are the most highly ranked in the search results for this user. Conversely, the graphic designer would be presented with search results ordered in a way such that the document accessed often by other graphic designers were the most highly ranked. For example, it might be that the documents relating to art museums are the most highly ranked.

In addition to tracking how many and/or how often users with a particular personal background trait access a given document or site (as described above), embodiments of the present invention disclosed herein may further provide methods adapted to allow the users to rate documents (e.g., websites) by submitting rating data. Accordingly, rating data submitted by a user (i.e., explicit rating data) is correlated with the user's personal background data and can be correlated with the advanced usage information of the document. In one embodiment, explicit rating data can optionally be obtained via ratings received from a user when prompted by the search engine (e.g., asking the user to rate the usefulness of the document after it has been reviewed). The rating can be binary (e.g., useful/not-useful) or can be numerical, i.e., given on a continuous rating scale (e.g., a usefulness rating scale from 1 to 10, 1 being the least useful and 10 being the most useful). In this way, a user who is, for example, a college professor and who searches for information about global warming can rate each document he or she reviews, the rating information being added to the advanced usage information store for that document. Using the methods and systems disclosed herein, the advanced usage information store correlates the rating data given by the user with that user's personal background data. In this way, the advanced usage information stored for the global warming document described in the example above will be updated with the rating data given by the college professor and correlated with information derived from his personal background data. For example, if the professor had rated the document with a relatively high usefulness rating of 8.5 on the aforementioned usefulness rating scale ranging from 1 to 10, the advanced usage information will be updated with an indication that the document was found highly useful by a user. Furthermore, the advanced usage information will be updated with correlation information that it was found highly useful by a user whose highest level of education was a Ph.D. Still furthermore, the advanced usage information will be updated with correlation information that it was found highly useful by a user whose profession is college professor. Assuming that this same document is accessed by many users who also rate it in this way, the ratings being correlated with personal background traits of those users, the resultant advanced usage information for that document provides highly valuable statistical correlations that can be used to order future search results as described by the methods herein.

Embodiments of the present invention disclosed herein may further provide methods adapted to imply a rating for a given document in addition to, or instead of receiving an explicit rating. Accordingly, additional preference data (i.e., implicit rating data derived from the user's actions with respect to a document) can be added to the advanced usage information stored for a given document.

For example, one embodiment of the present invention disclosed herein provides a method adapted to monitor user's local computer to determine whether that user prints a given document that has been received over the internet. If the user has printed some or all of a given document, it can be inferred with a high probability that that user found the document to be important and/or useful. When such a determination is made, the advanced usage information for the given document can be automatically updated with data representing a strong indication of user preference for the document. The advanced usage information can be updated by, for example, automatically assigning a high value on a usefulness rating scale and incorporating the assigned value into the advanced usage information for the given document. Furthermore, the assigned rating, indicating high usefulness, can be correlated with one or more personal background traits for the user who has searched for and then printed the document in question, wherein the personal background traits are derived from the personal background data for that user.

In practice, some users are more likely to print documents than other users. In fact, some users may print very freely, printing a large percentage of what they retrieve in an internet search, while other users may be very selecting in their printing. To accommodate for such differences in printing habits, an additional embodiment provides a method adapted to track a user's “print ratio”. As used herein, a “print ratio” refers to the number of documents retrieved by a user through an internet search that the user prints (completely or partially) during a given time period (e.g., a month) divided by the total number of documents retrieved by the user through internet searches during that same time period. For example, a first user may have printed 55 documents that were retrieved through internet searches performed on that user's office computer during the last 30 days. During that same 30 day period, that same user may have retrieved and accessed a total of 844 documents. Thus, the print ratio for the first user is 55/844, i.e., 6.5%. A second user might have a print ratio of 122/655, i.e., 18.6%. Based on such information, it can be inferred that the second user is more likely to print documents retrieved off the web than the first user. Hence, the print ratio can be used as a weighting factor to scale the significance (or insignificance) that a given user prints a particular document during a search. A user who has a very low print ratio (e.g., less than 2%) can be deemed as being very unlikely to print documents retrieved from the web. Therefore, when it is recognized that such a user prints a document retrieved from the web, the embodiment described in the previous paragraph can be augmented by assigning a particularly high preference or usefulness value in the advanced usage information associated with the retrieved document. On the other hand, a user who has a very high print ratio (e.g., more than 90%) can be deemed as being very likely to print most documents retrieved off the web. Therefore, when it is recognized that such a user prints a document retrieved off the web, the embodiment described in the previous paragraph can be augmented such that the printing does not result in assigning a particularly high preference or usefulness value in the advanced usage information associated with the retrieved document.

Embodiments of the present invention disclosed herein may further provide methods adapted to add additional preference data to the advanced usage information stored for a given document, wherein the amount of time that a user spends reviewing that document is monitored. If the user has spent a large amount of time reviewing a given document, it can be inferred with a high probability that that user found the document to be important and/or useful. For example, if the college professor in the example above spends 22 minutes reviewing a particular document on global warming, it can be inferred that the document was highly useful to the user. If, on the other hand, the college professor spent only 2 minutes reviewing a particular document, it can be inferred that the document was not highly useful to the user. Because documents are of varying lengths, it is often more valuable to assess time spent per some unit length of a given document rather than time spent on an entire document. To accommodate varying lengths of documents, an additional embodiment provides a method adapted to compute a “time-length ratio.” As used herein, a “time-length ratio” refers to the amount of time the user spends reviewing a particular document divided by the length of the document. In some embodiments, time spent is measured in seconds and document length is measured in characters. In such embodiments, the time-length ratio is the number of seconds the user spends reviewing the document divided by the number of characters present in the given document. If the document also includes pictures, the picture can be accounted for in document length, wherein the picture is treated as a certain number of characters to be added to the character count. The number of characters that a picture adds to the character count can be a constant (e.g., 400 characters), or it can be scaled based upon the size and/or resolution of the image, wherein a larger and/or higher resolution image is counted as more characters than a smaller and/or lower resolution image.

In practice, users typically read at different rates. To accommodate for such differences in reading proficiency, an additional embodiment provides a method adapted to compute a “normalized time-length ratio.” As used herein, a “normalized time-length ratio” refers to the absolute amount of time a user spends reading a document, normalized using historical data regarding how much time the user typically spends on similar documents, thereby identifying a relative amount of time a user spends reading a document. Accordingly, the normalized time-length ratio can be computed by dividing the aforementioned time-length ratio for a given document with a historical average of time-length ratios that have been generated for that user for other documents. In this way, the normalized time-length ratio can be used as a measure of how much time-per-unit-length the user spends on a current as compared to how much time-per-unit-length the user typically spends on other documents. For example, the college professor could, in the example above, have a historical average stored for him in memory that indicates he typically spends 21 seconds per 1000 characters present in a given document. When reviewing a current document, it can be determined by software accessing a system clock that he has spent 871 seconds reviewing a document that has 21077 characters. The software may then compute a time-length ratio of 871/21077and normalize the computed time-length ratio by his historical average of 21/1000, yielding a normalized time-length ratio of 1.97. A normalized time-length ratio of 1.97 means that the college professor has spent approximately twice as long reviewing the given document as compared to how long he typically spends reviewing documents. This normalized time-length ratio is, therefore, an indication that the user likely found the document more useful than most. Had the normalized time-length ratio been computed as a value that was less than 1.0, it would have indicated that the user spent less time reviewing the document than most documents he reviews—an indication that the user likely found the document to be less useful than most. Using the method and system disclosed herein, the normalized time-length ratio can be stored within the advanced usage information for the current document being reviewed and correlated with traits retrieved from the user's personal background data. For example, if the user who had retrieved the document above was a Republican, a college professor, and a person who had earned a Ph.D. as his highest education, the advanced usage information store would be updated to include the fact that a user spent about twice his typical time reviewing this document, that user is a Republican, a college professor, and a person with a highest education level of Ph.D. This updated advanced usage information could then be used in the future when other users access this particular document, providing valuable statistical correlations, the correlations being used to better order search results as described by the methods herein.

As described in the paragraph above, some embodiments of the present invention make use of a clock (e.g., a system clock on the user's computer), to determine how much time that user spends reviewing a particular document. This time can be computed simply as the elapsed time between the moment the document is opened and the moment the document is closed. While this method can be effective, it is prone to errors. For example, a user might open multiple documents simultaneously and switch back and forth between them. Accordingly, numerous embodiments are herein described that are adapted to derive a more accurate measure of time that a user spends reviewing a particular document. In one such embodiment, the system clock only tallies elapsed time during periods when the document in question is the active window on the user's desktop (assuming a Window's style user interface). In this way, if the user is switching back and forth between multiple documents, only the time during which a given document is the active document is the elapsed time tallied, yielding a more accurate measure. In practice, the above-described embodiment may not account for the fact that the user may give attention to other things not present on his or her computer (e.g., turn to watch television, answer a telephone call, go to the bathroom) or simply take a break, during which time the given document is both opened and active upon the user's desktop. Accordingly, and in another embodiment, the amount of time that a user spends reviewing a particular document is computed by tallying the elapsed time between the document being opened and the document being closed only when the given document is active and also only during times when the user interface device of the system (e.g., the mouse, touchpad, trackball, touch-screen, keyboard, voice recognition system) has not sat idle for more than a given threshold of time. For example, if the user has not generated any detectable input on his mouse, keyboard, touchpad, or other input device for some amount of time more than the time he or she typically takes to review a single screen-full of information, it can be inferred that the user is not actively reviewing that information any more because if he or she was, he or she would likely need to advance the document by scrolling, page advancing, or otherwise interacting with his or her user interface device. For example, the software can be configured to measure through historical averaging that a given user typically spends N seconds to review a screen-full of information. Furthermore, the system can be configured to presume a user is no longer reviewing a document if he or she spends 1.5 N seconds reviewing a document without providing any input to the computer through the mouse, keyboard, or other input device. If that amount of time (i.e., 1.5 N seconds) elapses during which no input is detected, the software tallying the time spent measure for that document will cease tallying. The software will resume tallying once input is received again from the given user through one or more user interface devices. In this way, if a computer is configured with N=60 seconds and the user leaves the computer to answer the phone while in the middle of a document review, talks on the phone for 20 minutes, then returns to continue reviewing the document—the majority of the time elapsed during the 20 minute phone call will not be included in the tally of time spent because the software would determine after 1.5 N (or 90 seconds) that no input was received through the mouse, keyboard, or other interface device, and would cease tallying the elapsed time spent until the user returned and began engaging the mouse, keyboard, or other interface device again.

This last method described in the paragraph above avoids many problems but is still prone to certain errors because a user might review a document and not engage his user interface for a long period of time; not because he has left the document, but because he is reviewing very carefully. To provide an even more accurate measure of time spent, yet another embodiment of the present invention uses a video camera—a common peripheral on many computer systems. The video camera can be suitable configured (e.g., via image processing techniques currently known in the art for head tracking, gesture tracking, eye tracking, and/or user identification) to determine if a user is currently present at the computer or not. Using such a camera and image processing techniques, the methods to measure time spent disclosed in the paragraph above can be augmented with a camera based determination of when a given user leaves his or her computer or turns away from his or her computer screen to focus on other things (e.g., a book, a phone conversation, etc.) as determined by the location and/or direction the user's body, user's head, and/or user's eyes. When the user is determined not to be present at the computer, not to be looking at the computer, or not to be looking at the document in question as displayed upon the computer, the software method that is tallying time spent can cease tallying until the user either returns to the computer, returns his gaze to the computer screen, and/or returns his gaze to the document in question upon the computer screen. In this way, the software can generate a highly accurate measure of time spent by a user reviewing a particular document.

In practice, users often print some or all of a given document and review the hard-copy of the document rather than reviewing the document on the computer. As a result, measures of time spent, obtained as described above, may not be accurate. To accommodate for the possibility of inaccuracies in time spent measures, an additional embodiment provides a software method adapted to identify when a given document is printed and automatically adjust a value of the time spent measure to some high number with the presumption that the user printed the document so that he or she can review the document in substantial detail. Although this presumption may not always be accurate (e.g., the user may have printed the document simply to keep a hardcopy), the fact that the document was printed is very likely an indication that the user found the document to be important and/or useful. Thus, setting the time spent value to some high number (i.e., a number that would produce a high normalized time-length ratio) when it is identified that the user has printed part or all of the given document, may be an effective way of monitoring that a given document is likely of importance and/or useful to the given user.

In accordance with many embodiments of the present invention, the personal background data associated with a given user can be entered and/or stored in a variety of ways. For example, the personal background data may be stored in one or more locations including, but not limited to, a client computer (e.g., the user's personal computer, the user's PDA, or the user's cell phone, or the like, or combinations thereof), one or more server machines (e.g., a server associated with the search engine service that the user is accessing, a server associated with the internet service provider the user is using, or the like, or combinations thereof), or the like, or combinations thereof. In all cases, the personal background data can be stored using any suitable storage technology (e.g., magnetic storage, optical storage, flash memory, RAM, ROM, permanent data storage means, temporary data storage means, or the like, or combinations thereof). Because a user may conduct searches from a number of different computers and/or locations, one embodiment of the present invention stores personal background data either local to the mobile location of the user (e.g., in a cell phone, PDA, memory card, or other device that the user carries with him or her), is stored on a server accessible over the internet from a wide range of locations, or the like, or combinations thereof.

Many industrial applications now use radio frequency (RF) chip technology to automatically identify objects or people when they come within a certain proximity of a radio receiver. These applications range from tagging goods for inventory control to enabling fast payment at checkout lines. A range of RF chip technology is currently available, addressing each application's unique storage, range and security requirements. Sometimes this RF technology is referred to as an RFID tag, other times this RF technology is referred to as a contactless smartcard. Consistent with the numerous embodiments disclosed herein, personal background data for a given user can be stored within an RFID tag chip and/or contactless smartcard that the user keeps with himself or herself (e.g., either in a card stored within the user's wallet, an RFID chip attached to the user's keychain, an RFID chip affixed to an article of the user's clothes, an RFID chip affixed to a bracelet or other piece of jewelry worn by the user, or an RFID chip or smartcard affixed to or held within some other piece of personal property kept on or with the user, or the like, or combinations thereof). Accordingly, embodiments of the present invention allow a user to approach any computer equipped with a receiver for accessing and reading appropriate RFID chip technologies, wherein personal background data for the user can be automatically accessed by the computer and used when the user performs an Internet search on the computer. This accessing can happen automatically when the user comes within a certain distance of a computer equipped with the RF receiver technology or when the user initiates a web search when using a computer equipped with RFID technology. Either way, the RF-ID chip technology disclosed herein enables a user to approach a computer and search the internet, wherein the search results being ordered using that user's personal background data, the personal background data being accessed over a radio link between the computer and an RD-ID tag worn, held, or otherwise kept in close proximity of the user.

In addition to, or instead of the aforementioned advanced usage information reflecting the number of users and/or frequency of users possessing one or more personal background traits who have visited a particular web site, an assigned correlation may be set for a particular web site, wherein the assigned correlation reflects the likely relevance of that site to a user who possesses one or more personal background traits. For example, a website could be assigned a high correlation factor with the political affiliation personal background trait of Democrat. This assigned correlation can be set by an author of the web document, an owner of the web document, the host of the web document, or by some other party. The assigned correlation can be stored on the server along with the document itself or it can be stored on a remote server or proxy server. In some embodiments, the assigned correlation is used by the ordering algorithm, more favorably ordering those documents that have an assigned correlation that correlate well with personal background traits of the user who initiated a given search.

While the invention herein disclosed has been described by means of specific embodiments, examples and applications thereof, numerous modifications and variations could be made thereto by those skilled in the art without departing from the scope of the invention set forth in the claims.

What is claimed is:

1. A computerized method of organizing a set of documents, comprising:
receiving a search query from a user;
obtaining personal background data from the user;
identifying at least one personal background trait within the personal background data, the personal background trait being statistically correlated with documents that the user is likely to prefer;
identifying a plurality of documents responsive to the search query;
assigning a score to each identified document based upon a correlation between advanced usage information for each document and the identified personal background trait, the advanced usage information describing at least one of a number and frequency of users who have previously accessed the document who possess the identified personal background trait; and
organizing the documents based at least in part on the assigned score.

2. The computerized method of claim 1, wherein the step of obtaining the personal background data includes accessing personal background data from a client computer.

3. The computerized method of claim 1, wherein the step of obtaining the personal background data includes accessing personal background data from a server machine.

4. The computerized method of claim 1, wherein the step of obtaining the personal background data includes receiving a query response from the user.

5. The computerized method of claim 1, further comprising:
identifying a plurality of personal background traits within the personal background data; and
assigning a score to each identified document based upon a correlation between advanced usage information for each document and each identified personal background trait.

6. The computerized method of claim 1, wherein the step of identifying the personal background trait from within the personal background data includes identifying at least one of a political association of the user, a highest level of education of the user, a profession of the user, a marital status of the user, and a reading level of the user.

7. The computerized method of claim 1, the step of identifying the personal background trait from within the personal background data includes identifying a value associated with the personal background trait.

8. The computerized method of claim 7, wherein the value associated with the personal background trait represents an association of the personal background trait with the user.

9. The computerized method of claim 8, wherein the value associated with the personal background trait represents a degree of association of the personal background trait with the user.

10. The computerized method of claim 7, wherein the value associated with the personal background trait represents a relative importance of the personal background trait with respect to other personal background traits within the personal background data.

11. The computerized method of claim 1, further comprising:
correlating the advanced usage information for each document with additional information for that document, wherein
the step of assigning a score to each identified document includes:
assigning a score to each identified document based upon the correlation between the additional information for each document and the identified personal background trait.

12. The computerized method of claim 11, wherein the additional information includes rating data for the identified document, the rating data indicating a level of usefulness of the identified document to one or more previous users who accessed the document and possessed the identified personal background trait.

13. The computerized method of claim 12, wherein the rating data is identified as a binary or numerical value.

14. The computerized method of claim 12, further comprising receiving rating data from the user.

15. The computerized method of claim 12, further comprising deriving rating data from the user's actions.

16. The computerized method of claim 15, wherein the step of deriving rating data includes:
determining whether the user prints an organized document; and
generating the rating data when it is determined that the user prints the organized document.

17. The computerized method of claim 15, wherein the step of deriving rating data includes:
determining an amount of time the user spends reviewing an organized document; and
generating the rating data based on the determined amount of time.

18. The computerized method of claim 15, wherein the step of deriving rating data includes:
determining an amount of time the user spends reviewing an organized document;
determining whether the user prints an organized document; and
generating the rating data based on the determined amount of time and when it is determined that the user prints the organized document.

19. An apparatus for organizing a set of documents, comprising:
means for receiving a search query from a user;
means for obtaining personal background data from the user;
means for identifying at least one personal background trait within the personal background data, the personal background trait being statistically correlated with documents that the user is likely to prefer;
means for identifying a plurality of documents responsive to the search query;
means for assigning a score to each identified document based upon a correlation between advanced usage information for each document and the identified personal background trait, the advanced usage information describing at least one of a number and frequency of users who have previously accessed the document who possess the identified personal background trait; and
means for organizing the documents based at least in part on the assigned score.

20. An apparatus for organizing a set of documents, comprising:
circuitry having executable instructions; and
at least one processor configured to execute the program instructions to perform operations of:
receiving a search query from a user;
obtaining personal background data from the user;
identifying at least one personal background trait within the personal background data, the personal background trait being statistically correlated with documents that the user is likely to prefer;
identifying a plurality of documents responsive to the search query;
assigning a score to each identified document based upon a correlation between advanced usage information for each document and the identified personal background trait, the advanced usage information describing at least one of a number and frequency of users who have previously accessed the document who possess the identified personal background trait; and
organizing the documents based at least in part on the assigned score.
